(19) United States
(12) Patent Application Publication
(10) Pub. No.: US 2007/0130333 A1
(43) Pub. Date: Jun. 7, 2007

(54) WIRELESS APPLICATION CONNECTION AUTO-DETECTION MECHANISM

(76) Inventors: Sanjeev Bhalla, Sunnyvale, CA (US); William J. Barhydt, Los Gatos, CA (US)

Correspondence Address: ORRICK, HERRINGTON & SUTCLIFFE, LLP;IP PROSECUTION DEPARTMENT, 4 PARK PLAZA, SUITE 1600, IRVINE, CA, 92614-2558, US

(21) Appl. No.: 11/566,527

(22) Filed: Dec. 4, 2006

Related U.S. Application Data
(60) Provisional application No. 60/741,717, filed on Dec. 2, 2005.

(51) Int. Cl. G06F 15/173

(52) U.S. Cl. 709/224; 709/203; 719/328

(57) ABSTRACT

The present invention provide Auto Detect mechanisms to automatically determine the connectivity configuration of a handset. The Auto Detect mechanisms are used to develop applications that do not require connection configurations from the user and that work with handset settings as they are, whether the wireless device is set for WAP access or Direct HTTP access. The Auto Detect mechanisms enable applications to auto-detect and use the correct setting for connecting to a backend server, which may depend upon the wireless network, the handset, and the handset configuration.

### RELATED APPLICATION

This application claims the benefit of U.S. Provisional Application Ser. No. 60/741,717, filed on Dec. 2, 2005.

### FIELD OF THE INVENTION

The present invention relates to determining the wireless data connectivity on a wireless device for use by wireless applications.

### BACKGROUND OF THE INVENTION

In developing and deploying wireless applications that leverage wireless connectivity, a Content Provider creates a Wireless Application as well as Backend Infrastructure. The Content Provider Wireless Application runs on the Wireless Device and communicates to the backend Content Provider Backend Infrastructure through a layer of systems—Wireless Device Operating Environment (e.g. Java runtime environment or Symbian runtime environment) which communicates with Wireless Network Infrastructure which connects to Internet Infrastructure and through it to the Content Provider Backend Infrastructure. FIG. 1 is a block diagram showing these layers of systems.

Many of the protocols of the Wireless data (e.g. GPRS, CDMA, 1xRT) and the Internet (e.g. HTTP, DNS) are used in this communication.

These features of data connectivity are made available to the wireless applications through two mechanisms: connectivity through WAP (Wireless Application Protocol) Gateways and Direct HTTP connectivity which does not go through a Wireless operator WAP Gateway. These are set up by configuring different APN (Access Point Network) settings in each wireless device. An APN setting specifies the IP address and Port number of the gateway through which communication traffic is routed for that network. These gateways act as a firewall and proxy server for the wireless network. For example, the APN setting for Vodafone's GPRS network for the WAP Gateway, at the time of writing this application, is IP address 212.183.137.12 and port number 8799.

Each Wireless operator sets its own policies on whether to allow certain kinds of access. For example, does the Wireless operator only allow access to approved sites (sometimes called White Listed)? Does the Wireless operator set the WAP APN as the default APN or does it setup the Internet APN as the default APN on various devices?

Wireless devices from different manufacturers (e.g., Nokia, Motorola, Sony Ericsson, etc.) each have their own mechanism for setting the wireless access points. Each handset has its own Menu system that allows a user to set or change the APN. On some handsets the APN setting applies to all access—whether through a WAP browser or through a Java application. However, on other handsets, e.g., many Sony Ericsson handsets, a separate setting is required for Java applications.

Wireless applications, written in Java or native handset operating systems such as Symbian, are designed with specific access mechanisms and require the user to ensure that their handset is configured appropriately for the network connectivity to work. For example, an application that uses Direct HTTP connectivity requires that a direct HTTP APN is set up by the operator or that the default APN set up allows unrestricted HTTP access.

This causes complexity and results in many customer complaints due to problems with wireless connectivity configuration on their wireless device. As an example, an application that is configured to work with Direct HTTP connection (the default when using standard Java HTTP connection APIs) would not work on a Samsung D500 on the Vodafone UK (United Kingdom) network. As another example, Samsung D600 works in Direct HTTP mode on Vodafone UK, but not on T-Mobile UK. As usage of wireless data increases, a large percentage of calls to a Network Operator call center are related to problems accessing backend platform resources from wireless applications.

### SUMMARY

The present invention provides Auto Detect mechanisms to automatically determine the connectivity configuration of a handset.

The Auto Detect mechanisms are used to develop applications that do not require connection configurations from the user and that work with handset settings as they are, whether the wireless device is set for WAP access or Direct HTTP access. The Auto Detect mechanisms enable applications to auto-detect and use the correct setting for connecting to a backend server, which may depend upon the wireless network, the handset, and the handset configuration.

### BRIEF DESCRIPTION OF THE FIGURES

FIG. 1 is a block diagram of the layers of systems for communication from the Content Provider Wireless Application to the Content Provider Backend Infrastructure.

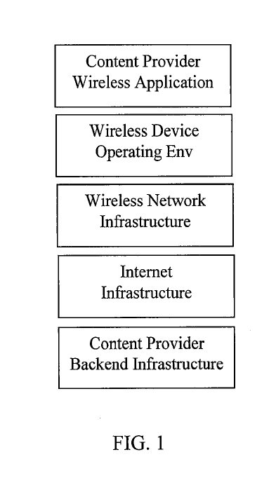

FIG. 2 is a block diagram of an exemplary handset on which the invention can be used.

FIG. 3 is a diagram showing examples of different connection paths between a wireless device and a server.

FIG. 4 is a flowchart showing a Wireless Connection Auto-Detection Mechanism according to an embodiment of the invention.

### DESCRIPTION OF INVENTION

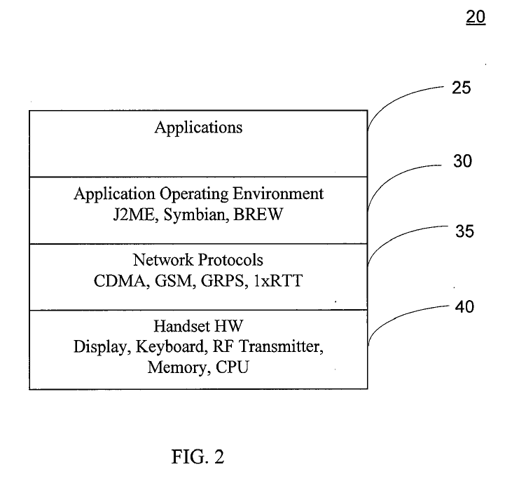

FIG. 2 shows a block diagram of an exemplary handset 20 on which the invention can be used. The handset 20 includes application programs 25 that run on top of the operating system 30 of the handheld device. Examples of operating systems for handheld devices include J2ME, Symbian, BREW, etc. The handset 20 uses a network protocol 35 to establish a wireless connection with a network. Examples of network protocols 35 include CDMA, GMS, GRPS, 1xRTT, etc. FIG. 2 also shows the hardware 40 of the handset. The hardware 40 includes a user interface, e.g., display and keyboard, an RF transmitter and receiver, memory, and a central processing unit (CPU). The application programs 25 are stored in memory and executed by the CPU.

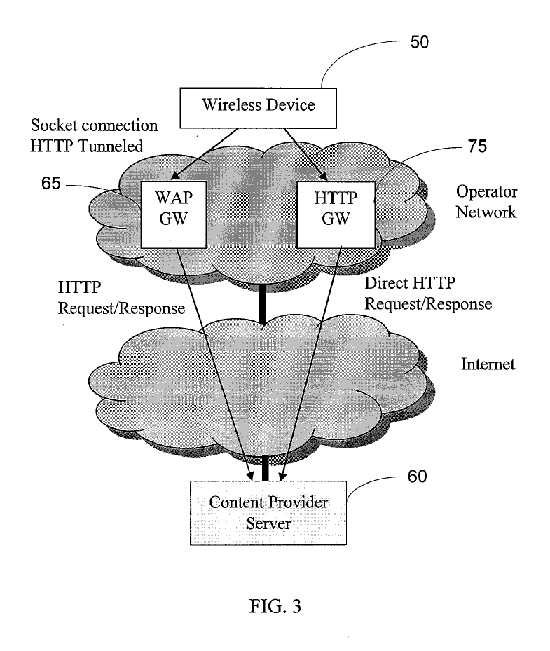

FIG. 3 is a diagram showing examples of different connection paths between a wireless device or handset 50 and a Content Provider Server or other Server 60. FIG. 3 shows an example of one path in which the wireless device 50 accesses the Server 60 through a WAP Gateway 65 for WAP access, and another path in which the wireless devices 50 accesses the Server through a HTTP Gateway 75 for Direct HTTP access.

According to a preferred embodiment, an Auto Detect application is provided that includes embedded algorithms to determine network connectivity. The Auto Detect application may be part of an application program utilizing wireless communications (e.g., compiled as part of the code of the application program), and may be downloaded as part of the application program when the application program is downloaded onto the handset. Examples of applications that would benefit from using the Auto Detect application include gaming applications, multi-user gaming applications, shopping applications, and mobile commerce applications that utilize connections to a backend server. Examples of gaming applications on handsets that utilize connections to a backend server are given in U.S. patent application Ser. No. 11/382,896, titles “System and Method for Mobile Loyalty Program”, filed on May 11, 2006, the specification of which is incorporated herein by reference. This Patent Application describes gaming applications that may connect to a backend server, e.g., to report user score to the server, to purchase tokens for pay-per-play games (e.g., play one game on the handset per token), etc.

Unlike current applications, which assume a Direct HTTP connectivity or connectivity through a network Gateway, the Auto Detect application is not embedded with a specific means of accessing server resources. Rather, the Auto Detect application is embedded with knowledge of WAP Proxy Servers for different Wireless Networks and the knowledge of different Wireless Network default access. For example, the Auto Detect application may be embedded with knowledge that Vodafone UK sets a WAP APN as the default APN on its handsets, and that T-Mobile UK allows Direct HTTP connectivity from a wireless device. This knowledge may be stored in the form of a table listing different Wireless Networks and their default access mechanisms.

There are two ways that the Auto Detect application may be used to determine the wireless network of the handset. First, the application may have a data file which is customized as the application is delivered on the various networks. Secondly, the application may retrieve certain properties from the handset which allow it to determine the network. For example, an application may retrieve the property wireless.messaging.sms.smsc to determine the SMS center number that the handset is using. SMS center numbers are unique to each network operator and a table of all known numbers can be embedded in the application which can consult the table in order to determine the network operator.

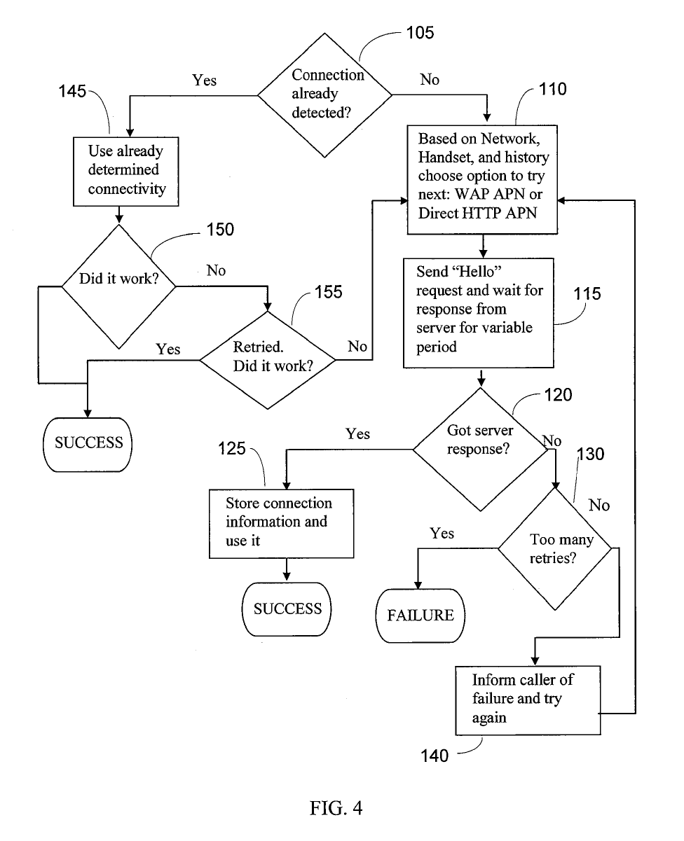

An Auto Detect mechanism according to an embodiment of the invention will now be described with reference to FIG. 4. In step 105, if a connection is not already detected, e.g., when an application using the Auto Detect mechanism is started on the Wireless Device for the first time, then the Auto Detect mechanism advances to step 110 and attempts to establish a connection to a known backend server. In step 110, the Auto Detect mechanism determines a connection mechanism for connecting to the server. The Auto Detect mechanism may try a connection mechanism that the application has successfully used for previous executions of the application to connect to the server, and stored in memory. The Auto Detect mechanism may also try a default or preferred connection mechanism for a given Network. The Auto Detect mechanism may determine the default or preferred connection mechanism for the given Network by consulting a table, as described above. The Auto Detect mechanism may first try connecting to the server using the stored connection mechanism before using the default or preferred connection mechanism. In step 115, the Auto Detect mechanism attempts to connect to the sever by sending a “Hello” request to the server using the connection mechanism determined in step 110. In step 120, the Auto Detect mechanism waits for a response from the server. If the server returns a response, then connection is established and the application uses the connection in step 125. The Auto Detect mechanism may also store the connection information in memory in step 125, and use the stored connection for future executions of the application.

If no response is returned, it could be that the access mechanism being used is not operational because of Handset or Network configuration. Alternatively, there may be a temporary error caused by lack of Wireless network coverage or other temporary causes.

The Auto Detect mechanism informs the application of the failure to connect, which updates the User Interface and informs the user. The Auto Detect mechanism then retries the connectivity to isolate temporary failures. If the Auto Detect mechanism determines that it has not tried too many times to connect in step 130, then the Auto Detect mechanism informs the user and tries again in step 140. The Auto Detect mechanism then goes back to step 110 and retires. The Auto Detect mechanism may retry using the same connection mechanism or an alternative connection or access mechanism to check if that path is working. In step 110, the Auto-Detect mechanism may determine which connection mechanism to use next based on the history of connection attempts. For example, if the Auto detect mechanism had tried WAP APN first without success, then it tries HTTP APN, and vice versa. In another example, after repeated failures (e.g., a predetermined number of failures) using a connection mechanism, the Auto-Detect mechanism retries using an alternative connection mechanism.

Eventually if the user wireless device has capability of data network access, the Auto Detect mechanism finds the path that works for that device and that network. It then remembers the setting by storing it in storage on the device in step 140 so that future executions of the application do not undergo the Auto Detect mechanism—rather they use the path that had been previously figured out.

In case there are repeated failures of connectivity—perhaps caused by change in configuration on the wireless device—the Auto Detect mechanism is retriggered to find again the path that works.

Because the J2ME specification does not allow the application to specify the different APNs to use when using HttpConnection class, a more complex mechanism to chose the APN is used. For Direct HTTP, the standard HttpConnection class is used. However, when trying a WAP APN, a socket connection with the WAP APN IP address and port is established using SocketConnection class. The application HTTP requests are then tunneled through such an established socket connection. This is indicated in FIG. 2 for the WAP access path. Pseudo code for performing a direct HTTP connection and a WAP connection in a J2ME environment are provided in the Appendix A.

While the Auto Detect mechanism is determining the path that works, it may use two mechanisms to provide good user experience. It first informs the application on each retry through a callback mechanism so that the user interface can be updated and the user informed of the retry. Second, the Auto Detect mechanism varies the time that it should wait for a response on each attempt by consulting a table which contains expected wait times given a network and a handset type. The information for these expected wait times is embedded in the Auto Detect mechanism. An exemplary table of expected wait times is given below.

TABLE 1
List of Default Configurations for Various Wireless Operators and
Various Handsets

| Operator | Handset | Default Mode | Wait Time (in sec) |
|---|---|---|---|
| Vodafone UK | Nokia 6620 | WAP APN | 25 sec |
| Vodafone UK | Samsung D500 | WAP APN | 40 sec |
| Vodafone UK | Samsung D600 | WAP APN | 40 sec |
| Vodafone UK | Motorola v600 | WAP APN | 25 sec |
| T-Mobile UK | Nokia 6620 | HTTP APN | 25 sec |
| T-Mobile UK | Samsung D500 | HTTP APN | 40 sec |
| T-Mobile UK | Samsung D600 | HTTP APN | 40 sec |
| T-Mobile UK | Motorola v600 | HTTP APN | 25 sec |

The expected wait time tables may be refined by having each Auto Detect enabled application send information about the response times it is observing in real use to the backend platform as part of normal usage. In order to conserve network bandwidth, this information is sent to the backend platform in piggyback fashion on normal requests that the application makes. This information is correlated on the backend platform that supports the Auto Detect applications. For example, the backend platform may compute average times that are being observed by an application on a given network and handset model. These average times may differ from the expected times hardcoded into the application. If so, these results can be tabulated and then used in newer applications that are developed using this mechanism.

If a connection is already detected in step 105, then the Auto Detect mechanism uses the already determined connection in step 145. If the connection fails to work in step 150, then the Auto Detect mechanism retries the connection in step 155. If the connection cannot be established in step 155, then the Auto Detect mechanism goes to step 110 to find a path that works.

While the invention is susceptible to various modifications, and alternative forms, specific examples thereof have been shown in the drawings and are herein described in detail. It should be understood, however, that the invention is not to be limited to the particular forms or methods disclosed, but to the contrary, the invention is to cover all modifications, equivalents and alternatives falling within the spirit and scope of this disclosure.

What is claimed:

1. A method for auto-detection of a wireless connection for an application on a wireless device, comprising:
attempting to establish a wireless connection using a first connection mechanism; and
if the attempt fails, attempting to establish a wireless connection using a second connection mechanism.

2. The method of claim 1, wherein the first connection mechanism uses a WAP APN and the second connection mechanism uses a Direct HTTP APN.

3. The method of claim 1, wherein the first connection mechanism uses a Direct HTTP APN and the second connection mechanism uses a WAP APN.

4. The method of claim 1, wherein if the first attempt to establish the wireless connection is successful, storing settings for the first connection mechanism on the wireless device, and using the stored settings to establish future wireless connections for subsequent executions of the application on the wireless device.

5. The method of claim 1, wherein if the second attempt to establish the wireless connection is successful, storing settings for the second connection mechanism on the wireless device, and using the stored settings to establish future wireless connections for subsequent executions of the application on the wireless device.

6. The method of claim 1, further comprising:
determining a default connection mechanism for a wireless network used by the wireless device; and
using the default connection mechanism as the first connection mechanism.

7. The method of claim 6, wherein determining the default connection comprises consulting a table listing different wireless networks and a default connection for each listed wireless network.

8. The method of claim 6, further comprising determining the wireless network used by the wireless device by retrieving properties of the wireless device stored on the wireless device.

9. The method of claim 8, wherein determining the default connection comprises consulting a table listing different wireless networks and a default connection for each listed wireless network.

10. The method of claim 1, wherein the first connection mechanism comprises a connection mechanism stored on the wireless device and successfully used to establish a wireless connection during a previous execution of the application.

11. The method of claim 1, wherein attempting to establish a wireless connection using the first connection mechanism comprises:
sending a request to a server using the first connection mechanism; and
waiting for a response from the server.

12. The method of claim 11, further comprising:
observing a response time for receiving the response from the server; and
sending information of the observed response time to the server.

13. The method of claim 12, further comprising:
waiting for the response from the server for a wait time based on a given wireless network and the wireless device.

14. The method of claim 1, wherein the application comprises a gaming application that utilizes wireless connection to a backend server.

15. The method of claim 1, wherein the application comprises a shopping application that utilizes wireless connection to a backend server.

16. The method of claim 1, wherein the application comprises a mobile commerce application that utilizes wireless connection to a backend server.

17. A wireless device, comprising:
an application stored on a storage medium, wherein the application comprises:
instructions for attempting to establish a wireless connection using a first connection mechanism; and
if the attempt fails, instructions for attempting to establish a wireless connection using a second connection mechanism.

18. The wireless device of claim 17, wherein the first connection mechanism uses a WAP APN and the second connection mechanism uses a Direct HTTP APN.

19. The wireless device claim 17, wherein the first connection mechanism uses a Direct HTTP APN and the second connection mechanism uses a WAP APN.

20. The wireless device claim 17, wherein if the first attempt to establish the wireless connection is successful, the application comprises instructions for storing settings for the first connection mechanism in the storage medium, and instructions for using the stored settings to establish future wireless connections for subsequent executions of the application on the wireless device.

21. The wireless device of claim 17, wherein if the second attempt to establish the wireless connection is successful, the application includes instructions for storing settings for the second connection mechanism on the wireless device, and instructions for using the stored settings to establish future wireless connections for subsequent executions of the application on the wireless device.

22. The wireless device of claim 17, wherein the application further comprises:
instructions for determining a default connection mechanism for a wireless network used by the wireless device; and
instructions for using the default connection mechanism as the first connection mechamsm.

23. The wherein device of claim 22, wherein the instructions for determining the default connection comprise instructions for consulting a table listing different wireless networks and a default connection for each listed wireless network.

24. The wireless device of claim 22, wherein the application further comprises instructions for determining the wireless network used by the wireless device by retrieving properties of the wireless device stored on the wireless device.

25. The wireless device of claim 24, wherein the instructions for determining the default connection comprise instructions for consulting a table listing different wireless networks and a default connection for each listed wireless network.

26. The wireless device of claim 17, wherein the first connection mechanism comprises a connection mechanism stored on the wireless device and successfully used to establish a wireless connection during a previous execution of the application.

27. The wireless device of claim 17, wherein the instructions for attempting to establish a wireless connection using the first connection mechanism comprises:
instructions for sending a request to a server using the first connection mechanism; and
instructions for waiting for a response from the server.

28. The wireless device of claim 27, wherein the application further comprises:
instructions for observing a response time for receiving the response from the server; and
instructions for sending information of the observed response time to the server.

29. The wireless device of claim 28, wherein the application further comprises:
instructions for waiting for the response from the server for a wait time based on a given wireless network and the wireless device.

30. The wireless device of claim 17, wherein the application comprises a gaming application that utilizes wireless connection to a backend server.

31. The wireless device of claim 17, wherein the application comprises a shopping application that utilizes wireless connection to a backend server.

32. The wireless device of claim 17, wherein the application comprises a mobile commerce application that utilizes wireless connection to a backend server.
